(19) United States
(12) Patent Application Publication
(10) Pub. No.: US 2014/0352896 A1
(43) Pub. Date: Dec. 4, 2014

(54) Network roller shutters

(71) Applicant: GYEONG-HAE HAN, Burnside (AU)

(72) Inventor: GYEONG-HAE HAN, Burnside (AU)

(21) Appl. No.: 13/905,135

(22) Filed: May 30, 2013

(51) Int. Cl. E06B 9/11

(52) U.S. Cl. CPC E06B 9/11
USPC 160/310

(57) ABSTRACT

The present invention relates to a network roller shutter system which can provide multi functions. The network roller shutter system has a constant current power supply (2) and one or a series of roller shutter controllers (3). The roller shutter controller includes a battery (33), the battery power is available in case of commercial AC power failure when emergency situations. The constant current power supply provides DC power to the batteries of all roller shutter controllers. The emergency switch (100) is connected between signal line and earth of power line to shut down all stutters simultaneously in emergency situations. The modem (35) is transmitting signals to all the roller shutter controllers. The microprocessor (31) monitors the voltage level of the constant current power supply and the battery (33) level. If the battery voltage level is lower than the minimum set limitation and other roller shutter controllers are not charging, the microprocessor turns on the switch (34) and then starts charging the battery (33).

### FIELD OF THE INVENTION

The present invention relates to network roller shutters of the type often referred to as “network roller shutters” or “network roller doors” or “network roller screens”, which have a flexible shutter or screen that is able to be raised and lowered by being wound onto and off a rotating shaft.

The network roller shutter is typically configured to be able to close off a window or a door or another similar opening although it will be appreciated that the shutter may also be used in situations where there is no obvious opening such as when the shutter is simply being used to form a barrier or shelter or the like.

The network roller shutter is operated by the command from home network servers or bushfire sensors or home security sensors.

### BACKGROUND OF THE INVENTION

The roller shutter provides protection against wind and rain. In roller shutter form, it is used in front of a window and protects the window from vandalism and burglary attempts.

Roller shutters have many applications, including doors for vans, garages, kitchens, schools, prisons and warehouses.

The tubular motor or another type of motor fitted within the roller shutter system provides a user friendly piece of equipment.

Apart from unsealed eaves, the most common way that a house is lost to bushfire is thought heat causing the windows to explode or excess heat is radiated and magnified through the glass causing curtains to burst into flames. A 90% reduction in radiant heat can be achieved by fitting the roller shutter helping to ensure that windows and other glass areas do not shatter thus preventing flames from entering the building. Further, by reducing the heat passing through the glass, curtains and other flammable internal fittings are protected against ignition from the external heat and flames. Wind turbulence will often carry debris that will shatter windows long before a fire arrives. The roller shutters prevent the debris from damaging the glass which causes the flames to enter a building.

The largest home insurer reports that 55% of domestic home break-ins are through unprotected windows.

The roller shutter can offer the first line of defence in this situation and has the major advantage of being a visual deterrent.

The roller shutters unique operation and locking device also offer a physical barrier against forced intrusion.

The insulating qualities of the roller shutter have the additional function of dampening the intrusion of unwanted noise by up to 50%. By creating a barrier in front of the window, the noise flow, which is transferred by vibrations through the air, is reduced.

The roller shutter system provides many benefits to the user. However, if the roller shutter is connected to a network, for examples, home network or home automation, it can provide further benefits to users.

The first benefit is monitoring the roller shutters from any places any time. If the monitor is located in the living room, the user can know which shutter is open or closed or partly open. If the monitor is connected with telephone line, the user can monitor the shutter status by telephone. If the monitor is connected with internet, user can monitor the shutter status by internet outside. Many mobile phones (Smart phone) have enough big size LCD to display the status of all shutter status with colorful graphic.

The second benefit is the ease with which problems in the shutter system can be diagnosed. If the shutter system sends a self-diagnosed report to the monitor having LCD screen or PC, the error mode is translated in the screen in detail. Therefore the users or service men can fix the part effectively.

The third benefit is that the all shutter systems operated automatically in the event of emergency conditions, for example, a bushfire. The network shutter system has battery in inside which can operate efficiently even though the commercial AC line is shut down due to heavy bushfire.

The fourth benefit is the provision of a number of functions of the roller shutter system. For example, one of possible scenario is that the home automation server or control server sends the wake up signal to the roller shutter in the morning; the network roller shutter opens slightly to help occupants to wake up or provide fresh air at that time. If a security sensor detects any attempt of intrusions, it sends the signal to the network roller shutter system; the proper position network roller system is operated to give warning of the intrusions. The possible scenarios are too numerous to mention in this patent.

This patent is effectively allowed converting the conventional roller shutter to a network enabled roller shutter system.

### BRIEF DESCRIPTION OF THE DRAWINGS

The invention is explained in further detail, and by the way of example, with reference to the accompanying drawings wherein.

FIG. 1 is a block diagram of network roller shutter system in accordance with this invention;

FIG. 2 is an operation timing chart diagram of constant current power supply in accordance with this invention;

FIG. 3 is a RS485 diagram of one of example of network roller shutter modem in accordance with this invention;

FIG. 4 is an operation timing chart diagram of RS485 in accordance with this invention. Other applications are;

FIG. 5 is a block diagram of network roller shutter system to give another application example;

FIG. 6 is a block diagram of network roller shutter system to give another application example;

FIG. 7 is a block diagram of network roller shutter system to give another application example;

FIG. 8 is a block diagram of network roller shutter system to give another application example;

FIG. 9 is a block diagram of network roller shutter system to give another application example;

FIG. 10 is a block diagram of network roller shutter system to give another application example;

FIG. 11 is a block diagram of network roller shutter system to give another application example;

FIG. 12 is a block diagram of network roller shutter system to give another application example;

### DETAILED DESCRIPTION OF THE INVENTION

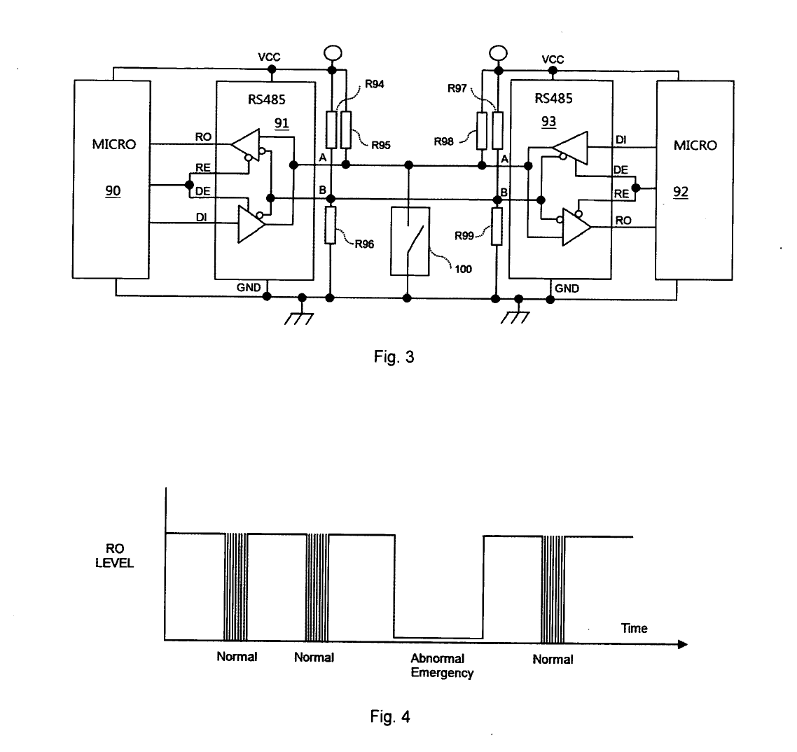

FIG. 1 is a block diagram of network roller shutter system in accordance with this invention. This network roller shutter system includes one or more roller shutter driving motors (5), one or a series of roller shutter controllers (3), a constant current power supply (CC SMPS) (2), a communication cable (4) and one or more emergency switch (100). The example roller shutter controller has a driver (32) for driving motor (5) and battery (33), a simple charging switch (34), a microprocessor (31), one or more button (36) and a modem (35) which is shown FIG. 3 as one of example solutions.

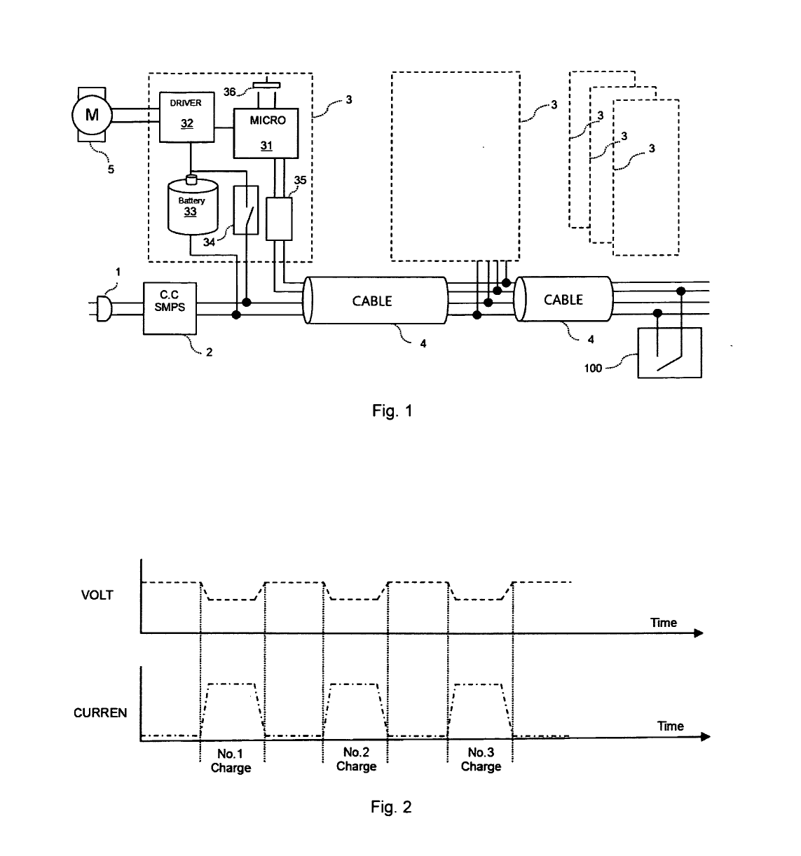

The constant current power supply (CC SMPS) (2) is connected to commercial AC line (1) and has the characteristics as the FIG. 2. The operation of the constant current power supply (2) is best illustrated by example. FIG. 2 illustrates an example implementation of constant current power supply (2). The microprocessor (31) checks the DC voltage level of the constant current power supply (2) to know whether other shutter controller (3) is charging or not. If the output voltage level of the constant current power supply (2) is high, it means there is no charging at this time, the microprocessor turns on the simple charging switch (34) to start charging the battery (33). If the output level of the constant current power supply (2) is low, it means that one of battery has already started charging, the microprocessor (61) is waiting until other battery pack finishes charging. This kind of sequence charging is possible for a small constant current power supply can provide power to all roller shutter controllers. This charging method needs just one AC commercial line plug and then provides low voltage network roller shutter system. It means that each roller shutter system does not need to be hard wired to a 240 volt commercial AC line, which also means that the wiring can be installed without the need for an electrical tradesperson.

The battery (33) provides enough initial starting power to the motor (5) to raise or close the shutter. The battery (33) is charged by the constant current power supply (CC SMPS) (2) when microprocessor (31) monitors its voltage and turns the simple switch (34). The battery can be replaced by a fuel cell or capacitor.

The button (36) has a basic interface function with the user, and then it sends a signal to microprocessor (31) whether the user want to do the roller shutters drive-up or down or stop. The button can be replaced by push button or slide switch, which has a central off position with an up and down position ether side. The button (36) may then be activated appropriately by the user to raise or lower the shutter as required. The motor (5) may also of course be stopped at any intermediate position between its lowermost and uppermost positions by pressing the button (36) or moving the switch to the off position.

The function of driver (32) is to give the power to roller shutter motor (5); it has also over current protection circuitry for protecting the circuitry as well as the battery (33) when motor has stuck or short.

The motor (5) used for motorized control of roller shutter, blanking or solar protection elements such as a curtain.

The cable (4) has a pair of power wires and one or two signal wires. All of roller shutter controllers are linked by this cable. The pair of power wires are connected to the constant current power supply (2).

the emergency switch (100) is illustrated as very simple switch as the FIG. 1 and FIG. 3. It can be a thermostat to check the outside temperature when bushfire and give the signal to all rollers shutter controllers (3) to close the shutter simultaneously. It can be a smoke alarm to check and control the all roller shutters or fire shutters immediately. The emergency switch (100) can be linked parallel to other Fire Alarm Systems to close automatically on event of fire alarm activation.

FIG. 3 shows well how to connect the emergency switch (100) in the communication cable (4). In this figure, the microprocessor (90) is the same as the microprocessor (31) in the FIG. 1. The RS485 (91) and bias resistors (94, 95, 96) are the same as the modem (35) in the FIG. 1. The microprocessor (92), the RS485 (93) and bias resistors (97, 98, 99) are illustrated the component of other roller shutter controller. The A pin of RS485 (91) is biased as higher level than B pin intentionally. It can make RO signal high when in idle condition. If the emergency switch (100) turns on, the A pin level is lower than B pin level, then the output RO will be low level. Without operating any emergency switch (100), the RS485(93) can transmit high speed data among the roller shutter controllers. The microprocessor (31 or 90) can recognize the signal is one of noise or not, and then operate the motor to close the shutter.

FIG. 4 shows well how to operate and illustrates an operation timing chart diagram of RS485 in accordance with this invention. RO level can be changed very frequently in normal conditions, in this time RO can transmit enough information to other controllers. However at the abnormal condition, RO is low for longer time than normal communication by the emergency switch (100). The microprocessor can recognize the signal is one of noise or not and then catch the longer low signal and act as the emergency operation already programmed. FIG. 3 illustrates just one emergency switch (100); however, several emergency switches can be connected by parallel.

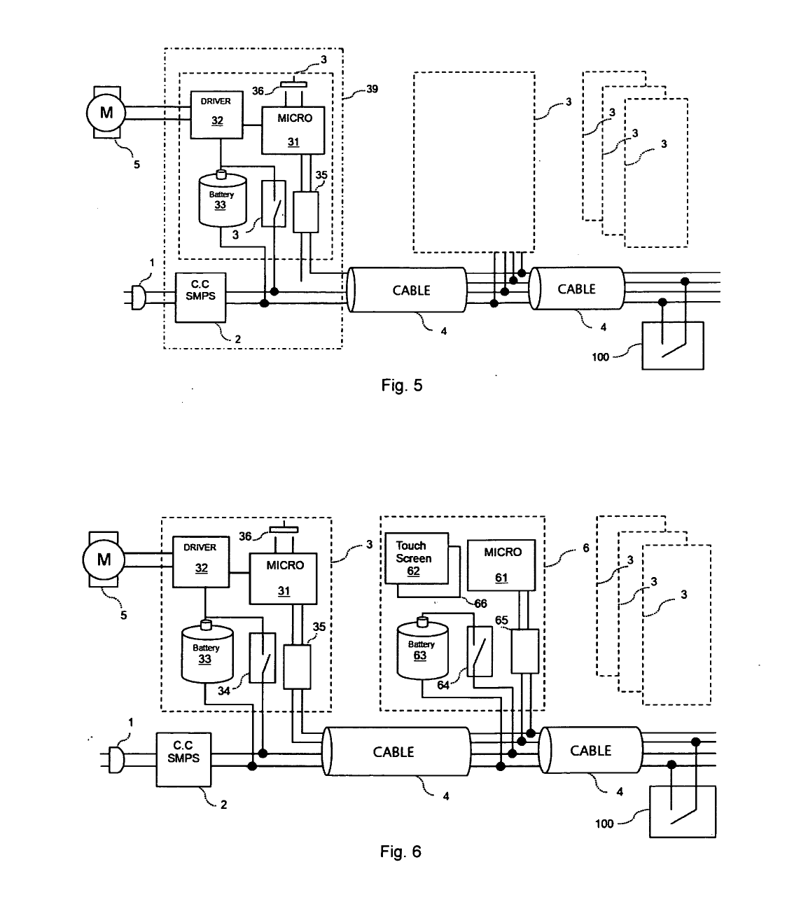

FIG. 5 is a block diagram of network roller shutter system to give another example. This system has one special roller shutter controllers (39) which embeds the constant current power supply (2) in its body. All components of this example are the same as FIG. 1.

FIG. 6 is a block diagram of network roller shutter system to give another example. This system has a control server (6). The functions of the other blocks are the same as FIG. 1. It shows just one constant current power supply (2) can provide power to all roller shutter controllers (3) as well as the control server (6).

The control server (6) has the same battery pack (63), the simple charging switch (64) and modem (65) as the roller shutter controller (3). As one of the examples, it has touch screen (62) and LCD (66) for user interface. It can provide graphic user interface (GUI) for user friendly operation. Some products of the control server (6) can be connected to telephone line or internet to be able to control and monitor the shutters outside.

The signal wires of the cable (4) are transmitting more information between the roller shutter controller (3) and the control server (6). The control server can control the roller shutter, up, down and stop, monitor the shutter position, battery voltage, charging current, discharging current and temperature, and diagnose the motor and all part of the roller shutter controller (3). If there is any malfunction, the microprocessor (31) sends the signal to the control server (6) that has a function to display the contents of the malfunction for the users.

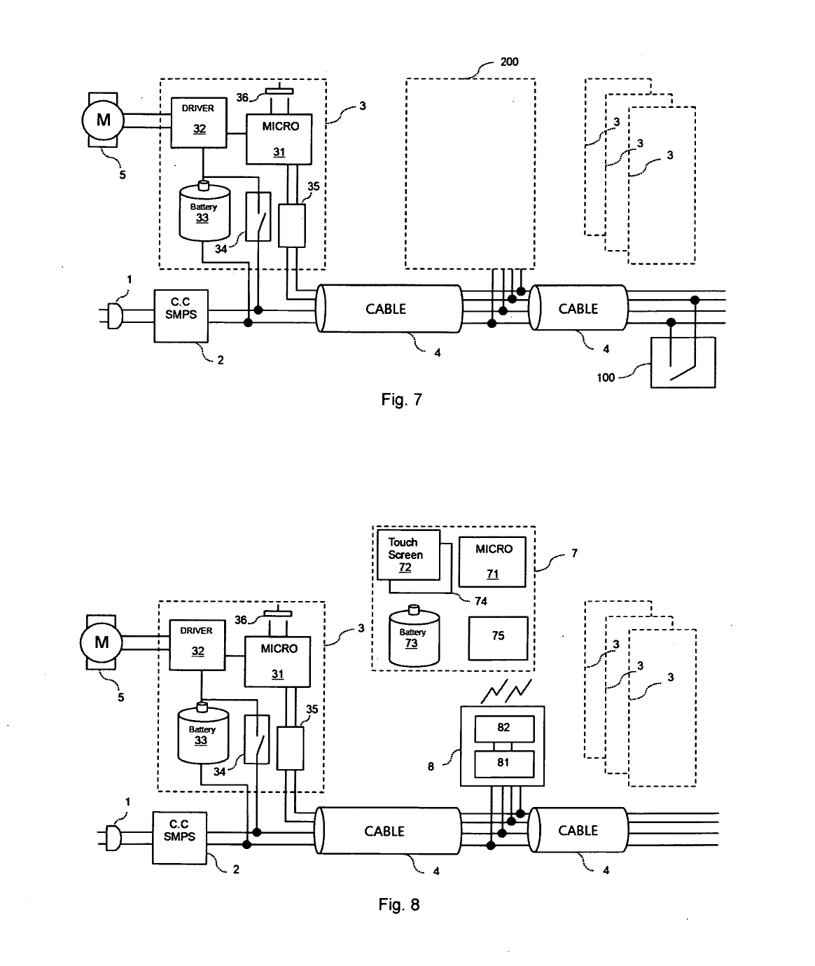

FIG. 7 is a block diagram of network roller shutter system to give another example. This system replaces the control server (6) at the FIG. 6 to other home network server (200). This means this network roller shutter system is merged easily as one of parts of the present application home automation system.

FIG. 8 is a block diagram of network roller shutter system to give another example. This system includes the bridge (8) has the same modem (81) as the modem (35) in the roller shutter controllers (3) and two way RF (radio Frequency) modem for communicating with the remote control server (7). The two ways RF modem can use the present application solution, for example, ZigBee, Bluetooth, Wireless LAN and 400 MHz RF. The main function of the bridge (8) is converting the signal from RS485 to RF or from RF to RS485. Generally speaking, two modems are directly connected in the bride (8). The remote control server (7) contains the battery (73), RF modem (75) the same as the RF modem (82) as the bride RF modem (82), touch screen (72) and LCD (74) for graphic user interface. The remote control server (7) can be replaced as a simple key and LED interface solutions. This solution can be included easily within the present application home automation solution or home network solution which has been already installed and operated in the user houses if the bridge (8) use the same type of RF modem.

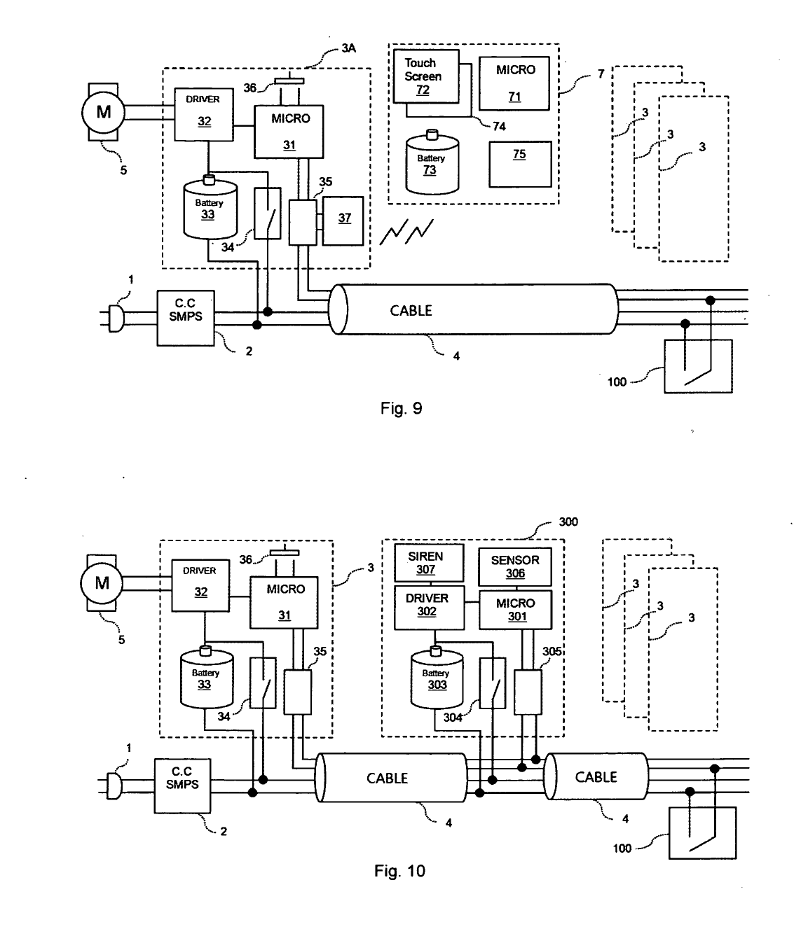

FIG. 9 is a block diagram of network roller shutter system to give another example. This system has one special roller shutter controllers (3A) which has the RF modem (37) in his body. This means the function of the bridge (8) in FIG. 5 is included in the special roller shutter controllers (3A). This solution also can be included easily within the present application home automation solution or home network solution which has been already installed and operated in the user houses when using the same type of RF modem.

FIG. 10 is a block diagram of network roller shutter system to give another example. This system shows the method of connection between the roller shutter controllers (3) and a security device (300).

The security device (300) has the same battery pack (303), the simple charging switch (304) and modem (305) as the roller shutter controller (3). The one constant current power supply (2) provides all power to the roller shutter controller as well as the security device (300). The roller shutter controller can control the security device via cable and the opposite case is possible.

FIG. 11 is a block diagram of network roller shutter system to give another example. This system has a bridge modem (84) having RS485 to RS232 converter. The bridge modem (84) can transmit all signals to PC (400). If service person has any PC having hyper terminal software, he/she can check all system within a short time and then fix easily.

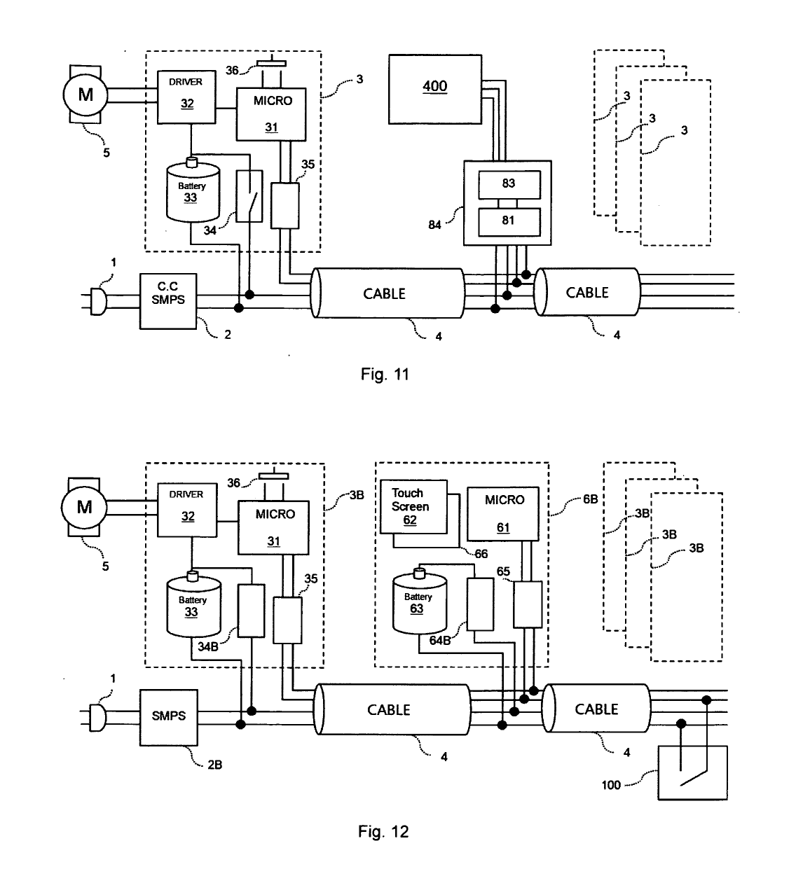

FIG. 12 is a block diagram of network roller shutter system to give another example. This system has a general type of power supply (2B). Modified roller shutter controllers (3B) have modified charging means (34B). A modified the control server (6B) has a modified charging means (64B).

The modified charging means (34B and 64B) has the proper charging characteristics according to the type of the battery. The microprocessor (61) of the control server (6B) asks the battery charging status to roller shutter controllers (3B) and gives the command to the shutter controller which has low battery charging status.

1. A network roller shutter system capable of providing electric power to electric motors of shutter, being controlled remotely, the shutter including a flexible shutter able to open and close by being wound onto and off a rotating shaft, wherein the network roller shutter system comprising:
(a) one or a series of roller shutter controllers having each battery for driving motor;
(b) a single constant current power supply for providing power to all the roller shutter controllers; and
(c) a cable to connect all the roller shutter controllers and the constant current power supply.

2. A network roller shutter system according to claim 1, wherein said constant current power supply has the voltage and current characteristics herein described in relation to FIG. 2.

3. A network roller shutter system according to claim 1, wherein said constant current power supply can be included in the said one of roller shutter controllers.

4. A network roller shutter system according to claim 1, wherein each of said roller shutter controller further comprises:
(a) a microprocessor for controlling and monitoring voltage of battery and said constant current power supply;
(b) a driver to give electric power to the motor;
(c) a battery for charging and discharging to give electric power even though AC commercial power off;
(d) a simple switch for charging the said battery; and
(e) a modem for transmitting signals.

5. A network roller shutter system according to claim 4, wherein each of said modem further comprises:
(a) a RS485 chip;
(b) a bias resistor connected between the RS485 A port to RS485 VCC;
(c) a bias resistor connected between the RS485 B port to RS485 VCC; and
(d) a bias resistor connected between the RS485 B port to RS485 GND.

6. A network roller shutter system capable of providing electric power to electric motors of shutter, being controlled remotely, the shutter including a flexible shutter able to open and close by being wound onto and off a rotating shaft, wherein the network roller shutter system comprising:
(a) three components described claim 1;
(b) one or a series of emergency switches connected between the GND of the said cable and one of signal line of the said cable.

7. A network roller shutter system according to claim 6, wherein said emergency switches comprise thermostats or security sensors or windstorm sensors.

8. A network roller shutter system capable of providing electric power to electric motors of shutter, being controlled remotely, the shutter including a flexible shutter able to open and close by being wound onto and off a rotating shaft, wherein the network roller shutter system comprising:
(a) three components described claim 1; and
(b) one or a series of control server connected with the said cable.

9. A network roller shutter system according to claim 8, wherein each of said control server further comprises:
(a) a microprocessor for controlling and monitoring voltage of battery and said constant current power supply;
(b) a display means for displaying for example LCD or LED;
(c) a user interface means for example, key pads or buttons;
(d) a battery for charging and discharging;
(e) a simple switch for charging the said battery; and
(f) a modem for transmitting signals.

10. A network roller shutter system capable of providing electric power to electric motors of shutter, being controlled remotely, the shutter including a flexible shutter able to open and close by being wound onto and off a rotating shaft, wherein the network roller shutter system comprising:
(a) three components described claim 1;
(b) a bridge modem converting the signal between serial and RF; and
(c) one or a series of remote controller having the same RF characteristics.

11. A network roller shutter system according to claim 10, wherein said bridge modem can be included in the said one of roller shutter controller.

12. A network roller shutter system capable of providing electric power to electric motors of shutter, being controlled remotely, the shutter including a flexible shutter able to open and close by being wound onto and off a rotating shaft, wherein the network roller shutter system comprising:
(a) three components described claim 1; and
(b) one or a series of security devices having the same as battery and modem.

13. A network roller shutter system according to claim 12, wherein each of said security device further comprises:
(a) a microprocessor for controlling and monitoring voltage of battery and said constant current power supply;
(b) one or a series of security sensors;
(c) a driver to operating sirens or other alarm devices;
(d) a battery for charging and discharging;
(e) a simple switch for charging the said battery; and
(f) a modem for transmitting signals.

14. A network roller shutter system capable of providing electric power to electric motors of shutter, being controlled remotely, the shutter including a flexible shutter able to open and close by being wound onto and off a rotating shaft, wherein the network roller shutter system comprising:
(a) three components described claim 1; and
(b) a bridge modem converting the signal between RS485 and RS232 for connecting with PC or other computers.

15. A network roller shutter system capable of providing electric power to electric motors of shutter, being controlled remotely, the shutter including a flexible shutter able to open and close by being wound onto and off a rotating shaft, wherein the network roller shutter system comprising:
(a) one or a series of roller shutter controllers having each battery for driving motors;
(b) a single power supply for providing power to the all roller shutter controllers;
(c) a cable to connect the all roller shutter controllers and the constant current power supply; and
(c) a control server connected with the said cable to know which roller shutter controller needs charging and give a command to start charging.

16. A network roller shutter system according to claim 15, wherein each of said roller shutter controller further comprises:
(a) a microprocessor for controlling and monitoring voltage of battery;
(b) a driver to give electric power to the motor;
(c) a battery for charging and discharging to give electric power even though AC commercial power off;
(d) a proper charging means according to the said battery characteristics; and
(e) a modem for transmitting signals.

17. A network roller shutter system according to claim 15, wherein each of said control server further comprises:
(a) a microprocessor controlling and monitoring voltage of battery;
(b) a display means for displaying for example LCD or LED;
(c) a user interface means for example, key or buttons;
(d) a battery for charging and discharging;
(e) a proper charging means according to the said battery characteristic; and
(f) a modem for transmitting signals.
